(19) United States
(12) Patent Application Publication
(10) Pub. No.: US 2005/0201505 A1
(43) Pub. Date: Sep. 15, 2005

(54) Enhanced separation process for (76Br, 77Br and 124I) preparation and recovery of each

(76) Inventors: Michael John Welch, Clayton, MO (US); Lucie Li Wa Tang, St. Louis, MO (US); Douglas J. Rowland JR., St. Louis, MO (US)

Correspondence Address: Patrick W. Rasche;Armstrong Teasdale LLP, One Metropolitan Square, Suite 2600, St. Louis, MO, 63102, US

(21) Appl. No.: 10/913,950

(22) Filed: Aug. 7, 2004

Related U.S. Application Data
(60) Provisional application No. 60/493,899, filed on Aug. 8, 2003.

(51) Int. Cl. G21G 1/06

(52) U.S. Cl. 376/168; 702/19

(57) ABSTRACT

An automated process for preparing and recovering ⁷⁶Br, ⁷⁷Br and ¹²⁴I comprises (I) bombarding enriched ^{76 or 77}Se or enriched ¹²⁴Te with a beam of protons on a targeted disk respectively to produce ⁷⁶Br, ⁷⁷Br and ¹²⁴I respectively wherein the target is selected from (a) a round tungsten disk with a depression at its center and (b) an inclined target having about a 20° inclination with respect to the beam direction and (II) recovering the ⁷⁶Br, ⁷⁷Br and ¹²⁴I in an automated process comprising by placing the irradiated target face up in a quartz tube in the center of a high temperature furnace utilizing a target holder and heating the irradiated target sufficient to release and recover ⁷⁶Br, ⁷⁷Br and ¹²⁴I therefrom.

This application claims the benefit of U.S. Provisional Patent Application Ser. No. 60/493,899, filed Aug. 8, 2003 which is incorporated herein in its entirety by reference.

### STATEMENT REGARDING FEDERALLY SPONSORED RESEARCH AND DEVELOPMENT

This research was funded by US DOE grant DEFG02-84ER-60218 and NCI grant R24 CA86307. The Government may have certain rights in the discovery.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This discovery relates to an automated process for separating, preparing and recovering each of emitting stable and purified (⁷⁶Br, ⁷⁷Br and ¹²⁴I) radionuclides each separately, independently and individually from a target. This discovery also relates to an automated process for recovering each of these radionuclides separately, independently and individually each having a purity (high) suitable for use in diagnostic and therapeutic radiopharmaceuticals for living mammals.

### BACKGROUND OF THE INVENTION

Radioactive halogens (⁷⁶Br, ⁷⁷Br and ¹²⁴I) are utilized extensively in radiopharmacy as individual radionuclides in the treatment and diagnosis of diseases such as cancer of living mammals. These radioactive halogenic radionuclides are useful as radionuclides for internal mammalian radiation therapy because of their toxicity to cancer and their characteristic intermediate half-life and multiple decay mode. ⁷⁶Br and ¹²⁴I are also useful for diagnosis of disease in general when an appropriate pharmaceutical drug compound targeting the disease is labeled with one of these two radionuclides. The disease can be identified through the use of Positron Emission Tomography “(PET)”.

Despite advances over the years in developing processes in the separation field for preparation of purified halogens produced using charged-particle accelerators a strong need still remains for an enhanced automated purification/refinement which can process large quantities of .sup.Br-76, .sup.Br-77 or .sup.I-124. (⁷⁶Br, ⁷⁷Br or ¹²⁴I.

### BRIEF DESCRIPTION OF THE INVENTION

In an aspect a functional automated operative method of recovering ⁷⁶Br, ⁷⁷Br and ¹²⁴I each isotope separately, independently and respectively from a nuclear bombarded (irradiated) target selected from a target configured as at least one of (a) a round tungsten disk and (b) an inclined or slanted target comprises placing the irradiated target face up in a quartz tube in the center of a furnace utilizing a target holder and heating the irradiated target sufficiently to release ⁷⁶Br, ⁷⁷Br or ¹²⁴I therefrom. In an aspect 3-way and 4-way solenoid valves are employed in the automated method. In an aspect the automated method is an automatic sequence system. In a further aspect the automatic sequence system is that control sequence shown in Table I. In an aspect each of ⁷⁶Br, ⁷⁷Br or ¹²⁴I are each prepared, isolated and recovered as an individual respective product and ready for use as radionuclides.

In an aspect the automated system is electrically/pneumatically communicatively configured capable and functional in all operationally necessary aspects.

In an aspect the disk has a configured depression at its center accommodable to receiving and holding material.

In an aspect the inclined or slanted target has about a 20° inclination with respect to an impinging radiation beam direction. In an aspect the angle of inclination (a critical parameter in this discovery) ranges from about 19.2° to about 20.8°.

In a further aspect the eluant exiting the cartridge of the system is purified and contains each of the desired recovered ⁷⁶Br, ⁷⁷Br or ¹²⁴I activity as each of recovered purified ⁷⁶Br, ⁷⁷Br or ¹²⁴I.

In an aspect a novel automated operative process for preparing and recovering ⁷⁶Br, ⁷⁷Br or ¹²⁴I comprises bombarding ⁷⁶Se, ⁷⁷Se or ¹²⁴Te with a beam of protons on a target disk to produce ⁷⁶Br, ⁷⁷Br or ¹²⁴I respectively wherein the target is selected from at least one of (a) a round tungsten and (b) an inclined target. Recovery of ⁷⁶Br, ⁷⁷Br or ¹²⁴I is performed by placing the irradiated target face up in a quartz tube in the center of a furnace utilizing a target holder and heating the irradiated target sufficient to release and recover ⁷⁶Br, ⁷⁷Br or ¹²⁴I therefrom using an automated control scheme. In an aspect the automated method is an automatic sequence system. In a further aspect the automatic sequence system is a control sequence shown in Table I or a sequence emulating that sequence. In an aspect the disk has a depression at its center. In an aspect the target has about a 20° inclination with respect to the beam direction.

In an aspect an apparatus operable and useful for recovering ⁷⁶Br, ⁷⁷Br or ¹²⁴I activity product prepared in a process comprises a target suitable for nuclear bombardment, the target selected from (a) a round tungsten disk and (b) an inclined or slanted target wherein the apparatus includes a 3-way and 4-way solenoid valves as part of an automated control system. In an aspect the disk has a suitably configured depression at its center. In an aspect the target has about a 20° angle of inclination with respect to the impinging radiation beam direction.

In an aspect an article of manufacture useful for preparing ⁷⁶Br, ⁷⁷Br or ¹²⁴I activity as a recovered product herein comprises a mechanical target suitable for nuclear bombardment, the target selected from (a) a round tungsten disk and (b) an inclined or slanted target wherein the operation of the article of manufacture is automated. In an aspect a disk having a suitable configured depression at its center. In an aspect a target having about a 20° inclination with respect to the impinging radiation beam direction.

In a further aspect of the aforementioned article of manufacture a support member for a target to be irradiated comprises a holder for the target having a configuration accommodating a material to be irradiated as a target. In an aspect the support member is configured as a spoon and has a configuration therein to uphold (a) a round tungsten disk or (b) an inclined or slanted target. In an aspect the support member comprises tantalum. In an aspect the holder is adapted to releasably hold the target for a time of acquisition. In an aspect a disk has a suitably configured depression at its center. In an aspect a target has about a 20° inclination with respect to the impinging radiation beam direction.

In an aspect a method of controlling an automated operative process for preparing and recovering ⁷⁶Br, ⁷⁷Br and 124I comprises bombarding ⁷⁶Se, ⁷⁷Se or ¹²⁴Te with a beam of protons on a target disk to produce ⁷⁶Br, ⁷⁷Br or ¹²⁴I respectively on a target wherein the target is selected from (a) a round tungsten disk and (b) an inclined target recovering the ⁷⁶Br, ⁷⁷Br or ¹²⁴I by placing the irradiated target face up in a quartz tube in the center of a furnace utilizing a target holder and heating the irradiated target sufficient to release and recover ⁷⁶Br, ⁷⁷Br and ¹²⁴I therefrom using an automated control scheme which comprises forming a database containing sequence control information and using that database to control the process and recovery each of ⁷⁶Br, ⁷⁷Br and ¹²⁴I as an individual product. In an aspect a disk has a depression at its center. In an aspect a target has about a 20° inclination with respect to the beam direction.

In an aspect a database comprises sequence valve information for controlling a novel automated operative process for preparing and recovering ⁷⁶Br, ⁷⁷Br or ¹²⁴I which comprises bombarding ^{76,77}Se or ¹²⁴Te with a beam of protons on a target disk to produce ⁷⁶Br, ⁷⁷Br or ¹²⁴I on a target respectively wherein the target is selected from at least one of (a) a round tungsten disk and (b) an inclined and recovering each individual ⁷⁶Br, ⁷⁷Br or ¹²⁴I by placing the irradiated target face up in a quartz tube in the center of a furnace utilizing a target holder and heating the irradiated target sufficient to release and recover each of individual purified ⁷⁶Br, ⁷⁷Br or ¹²⁴I therefrom using an automated control scheme wherein the database comprises a sequence of valve openings and valve closings. In an aspect a disk has a depression at its center. In an aspect a target has about a 20° inclination with respect to the beam direction.

### BRIEF DESCRIPTION OF THE DRAWINGS

Table 1 presents an operable illustrative Control Sequence for Halogen Separation and Purification.

FIG. 1 illustratively depicts an operative automatic halogen preparation and purification schematic having components capably coupled together as an enhanced separation process for ⁷⁶Br, ⁷⁷Br and ¹²⁴I production individually, separately, independently and respectively.

FIG. 2A illustratively shows a tantalum spoon, illustrative of a support member, in a unitized construction with an elongated rod length (dimensionally referenced by an accompanying metric ruler) useful to introduce target material to be melted on a disk or inclined target and also useful to introduce irradiated target(s) for the separation process for ⁷⁶Br, ⁷⁷Br and ¹²⁴I each separately and independently respectively.

FIG. 2B illustratively depicts three views of a tantalum spoon holder capable of holding both types of target; disk and inclined respectively, with dimension reference to a ruler.

FIG. 2C illustratively shows a detailed expanded dimensioned view of a machined spoon, also shown in right hand portion of FIG. 2B.

FIG. 3 shows three views of a Mellen 1300° C. Tubular Furnace (model TT13) useful during preparation of target material to melt the target material on a disk or inclined target and also for thermal distillation of the irradiated targets.

FIG. 4 shows a quartz tube useable for preparation of target material, thermal distillation of irradiated targets and recovery of activity.

FIG. 5 shows a 4-way solenoid operated valve (Bio Chem Valve, Inc., Series 080T) used to introduce the solvent rinse and to recover the activity in the collection vial.

FIG. 6 shows a 3-way valve solenoid operated valve (General Valve, Series 66) used to pressurize the collection vial to load the activity onto a C₁₈SepPak Cartridge and then into an empty syringe.

FIG. 7 shows a conventional high temperature oven (Lindberg®/Blue M®) useful in this discovery.

The discovery is described hereinafter in further detail with references to the aforedescribed Figures, in which like items are number the same in the aforedescribed Figures.

### DETAILED DESCRIPTION OF THE INVENTION

Briefly, in this discovery, isotopic ⁷⁶Br, ⁷⁷Br and ¹²⁴I product is recovered separately and independently from an irradiated target via a thermal distillation process using an automated processing scheme.

In an aspect, a small temperature tubular furnace is used for the recovery of ⁷⁶Br, ⁷⁷Br and ¹²⁴I separately, independently and respectively. Introduction and orientation of irradiated targets into the small high temperature tubular furnace is possible using a long rod with one end machined to accommodate with one of two geometrical configurations of targets: a flat round disk or an inclined target. The target is held by a target holder comprising a tantalum spoon. In an aspect the ⁷⁶Br, ⁷⁷Br or ¹²⁴I activity is carried through the process by an inert gas stream (such as Argon) and is deposited on the quartz tube wall on the smaller diameter side. The deposited ⁷⁶Br, ⁷⁷Br or ¹²⁴I activity is recovered in ammonium hydroxide NH₄OH and is passed through a Sep-Pak purifying cartridge or equivalent techniques for purification.

In an aspect the aforedescribed database, software, valves, vessels, nuclides and starting materials are assembled and setup in an operating assembly.

In an aspect a small temperature tubular furnace comprises an enclosed tubular shaped chamber in which heat is produced.

In an aspect a functional computer includes one which has the capability to house and operate the software necessary for this discovery and is fully communicative with all valves and associated tubing and equipment. It is understood that the term communicative includes full capability of sending, receiving and providing timely instruction to/from the equipment in accordance with the software and this discovery.

In an aspect, the former creates a small footprint.

In an aspect, the larger diameter side of the quartz tube is equipped with a Swagelok® Ultra-Torr® Vacuum Fitting Union made of Stainless Steel and mounted with a Kalrez® o'ring. This union seals the block holding the Tantalum spoon and the gas port to the quartz tube during operation. Any other techniques to seal could be employed for example a magnetic couple device.

In an aspect, the term “spoon” includes a custom-made receiving/holding receptacle adaptably configured to hold an object selected from one of such as (a) a round tungsten disk with a depression at its center and (b) an inclined target having about a 20° inclination with respect to the beam direction.

In an aspect, the entire assembly including the Mellen furnace or equivalent furnace is sufficiently small to be placed in a 28″L×21″H×18″W internal dimensional hotcell (enclosed radioactivity chamber).

Recovery of ⁷⁶Br, ⁷⁷Br and ¹²⁴I separately and independently from thermal distillation has been partially implemented for remote processing using solenoid 3-way and 4-way valves operated with switches which are hereinafter schematically illustrated in more detail.

Automation of the recovery process has been successful through a total of thirteen tests with ⁷⁶Br (ten) and ¹²⁴I (three). In addition, a high temperature Mellen tubular furnace (hereinafter described) has been used to “melt” a (¹²⁴Te) Cu₂Te target material onto a slanted target by heating at over 1100° C. This target was then irradiated for about 10 minutes at 4 different beam currents to test its integrity. Following these successful tests, the target was irradiated to produce the desired product radionuclide ¹²⁴I, which was recovered using a valve setup (Table 1) yielding successful results.

As used herein, the term “halogen” includes bromine or iodine, mixtures thereof. The symbol “Br” means bromine and the symbol “1” means iodine.

As used herein, the term “radiolabeled counterparts” includes respectively radiolabeled halogen compounds. As used herein, the term “purify” includes refine.

As used herein, the term “detectably labeled” includes the respective radiolabeled halogen compounds having an effective amount of an emitting radiolabel therewith and suitably accepting an emitting radiolabel for use in administration to living mammals and subsequently radioimaging diagnosis on that living mammal.

As used herein, the term “administration” includes the successful giving to and effective administration of a compound such as a radiolabeled tracer compound by any useful means to a living mammal and its successful introduction into the mammal internally such as in its gastrointestinal tract in an effective method which results in that compound, its salt, its ions, metabolites or derivatives being made biologically available to that mammal receiving administration of the compound for medicinal or therapeutic use. In an aspect the mammal is a human. In an aspect the mammal is a nonhuman such as a canine or feline. In an aspect the halogen compound is made biologically available to the gastrointestinal tract of the mammal patient. In an aspect the administration comprises giving of at least one of a bromine detectably labeled compound and a iodine detectably labeled compound to a living mammal for therapeutic use.

As used herein, the term “preparation, synthesis, purification and recovery” to such a state/condition ready for use such as use as a radionuclide with a tracer compound for diagnostic imaging in animals.

As used herein, the expression “pharmaceutically acceptable” applies to a composition comprising a compound or its ⁷⁶Br, ⁷⁷Br and ¹²⁴I individually radiolabeled counterpart herein which contains composition ingredients that are compatible with other ingredients of the composition as well as physiologically acceptable to the recipient, e.g. a mammal such as a human, without the resulting production of excessive undesirable and unacceptable physiological effects or a deleterious impact on the mammal being administered the pharmaceutical composition.

As used herein, the term “dosage” includes an effective amount of isotopic ⁷⁶Br, ⁷⁷Br and ¹²⁴I respectively labeled compound which when effectively administered to a living mammal provides an effective amount of biologically available halogen radionuclide labeled tracer compound to a living mammal such as in small animal imaging.

As used herein, the term “small animal imaging” includes imaging done on cats, dogs, mice, rats and rodents. As used herein the term “rodent” includes members of the Order of Rodentia including squirrels, rats, prairie dogs, porcupines, mice, lemmings, marmots, guinea pigs, hamsters, gophers, gerbils, chipmunks, chinchillas, capybaras, porcupines, ground squirrels and beaver.

In an aspect, as used herein the term “patient” includes a living human, and a living non-human such as non-human primate, feline, canine, horse, murine, rodents (including rats and mice). The term patient includes subject.

In an aspect a solid target is positioned in a suitable target holder and effectively irradiated with a beam of charged-particles generated by an accelerator aligned thereto. In an aspect the irradiated target is automatically and remotely transferred to a pneumatic or hydraulic transfer line and conveyed to an automated separation system for separation of the ⁷⁶Br, ⁷⁷Br and ¹²⁴I radionuclide of interest from reacted target material and from other radionuclides using 3-way and 4-way automatedly controlled solenoid valves.

In an aspect, ⁷⁶Br, ⁷⁷Br and ¹²⁴I are isolated and recovered as products of this discovery for further use such as a radiolabel attached to a tracer compound for use in a living animal. In an aspect the automated system is electrically/pneumatically communicatively configured capable and functional in all operationally necessary aspects.

Table 1 depicts an enhanced automated process schematic (control sequence) for separation and purification of ⁷⁶Br, ⁷⁷Br and ¹²⁴I isotopes according to this discovery.

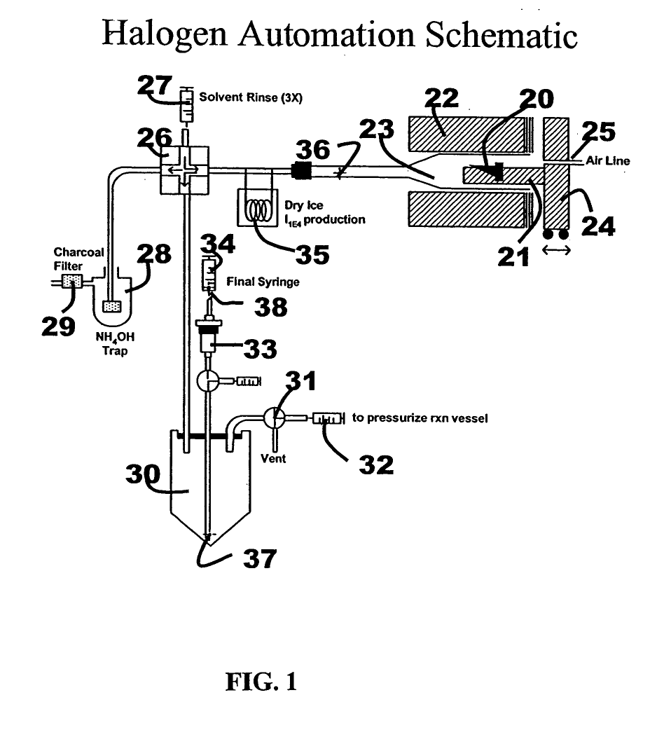

More in detail as to FIG. 1, irradiated target 20 sits on tantalum target holder 21 which introduces target 20 into the center of 1300° C. Furnace 22. Tantalum target holder 21 is mounted on block 24 having port 25 to allow argon (or any inert gas stream) through quartz tube 23. Block 24 seals the inlet. FIG. 1 illustrates the use of 3-way and 4-way solenoid valves.

During dry distillation process, argon or any inert gas stream (not labeled) passes through solenoid operated 4-way valve 26 and is collected into NH₄OH trap 28 equipped with charcoal filter 29.

Prefilled syringe 27 actuated by a linear motion cylinder introduces the solvent to recover the activity at one end on quartz tube 23 in the case of ⁷⁶Br, ⁷⁷Br, or to recover from the loop 35 for ¹²⁴I. The solvent passes through solenoid operated 4-way valve 26. The recovered activity is directed via solenoid operated 4-way valve 26 into the collection vial 30 which is vented using solenoid operated 3-way valve 31.

Once all (or substantially all) the activity is recovered from quartz tube 23, empty syringe 32 actuated by a linear motion cylinder pressurizes collection vessel 30 to load a C18 SepPak cartridge 33 or equivalent prior to final collection syringe 34.

Activity monitor 36 located at the end of quartz tube 23 records the recovery of activity. Activity monitor 37 located behind the collection vial 30 records the collected activity. Activity monitor 38 records recovered activity in final collection syringe 34 at the end of the process.

One practicing this discovery will understand that the process is monitored by a capable radiation detector at different locations of the automated process which monitors the displacement of radioactivity and also indicates the ratio of activity being separated. From this detector, any adjustment may be made to the process if necessary. All electrical power and pneumatic power is made available to the automatic process system to enable a capable successful carrying out of this discovery and recovery of the desired product.

Target Preparation for Nuclear Bombardment

⁷⁶Br, ⁷⁷Br and ¹²⁴I radionuclides are of great interest as they are used in PET imaging and as therapeutic agents. These radionuclides are produced via the (p,n) reaction on enriched target material: Copper Selenide (^{76 or 77}Se) Cu₂Se to produce ⁷⁶Br, ⁷⁷Br, or (¹²⁴Te) Cu₂Te to produce ¹²⁴I. Copper Selenide (^{76 or 77}Se) Cu₂Se and Copper Telluride (¹²⁴Te) Cu₂Te are prepared as follows: combined stoichiometric amounts (2:1) of enriched ⁶³Cu and enriched ^{76 or 77}Se or enriched ¹²⁴Te placed in an evacuated quartz ampoule are heated for about 6 to 10 days at ˜450° to 500° C. using a furnace. Enriched copper, selenium and tellurium come from ISOFLEX, San Francisco, Calif., USA and Isoflex AB Soldatyagen, 1 SE-783 50 GUSTAFS, Sweden or equivalent.

Illustratively the combined stoichiometric amounts of copper and selenium, or tellurium are pressed and melted on a solid disk target or melted on an inclined target, and irradiated on a small biomedical cyclotron using a 14.5 MeV proton beam. The stoichiometric amounts of copper and selenium, or tellurium are selected so as to twice the amount of copper atoms is mixed with a given number of atoms of tellurium or selenium in order to raise the thermal stability during bombardment of target material.

More in detail ^{76 or 77}Se or ¹²⁴Te with beams of protons from a biomedical cyclotron effectively impinging a disk to produce by the (p,n) nuclear reaction ⁷⁶Br, ⁷⁷Br and ¹²⁴I respectively wherein the target is selected from one of (a) round tungsten disk with a suitably configured depression at its center and (b) an inclined or slanted target having about a 20° inclination with respect to the impinging radiation beam direction. In an aspect, the impinging radiation is provided by a proton which is directed by suitable collimation means to the desired target utilizing an automated control system.

The automated system of this discovery can be readily adapted to the production of ¹²⁴I utilizing tellurium dioxide as a target material. The temperature would be reduced from 1100° C. to about 700° C.

Tellurium dioxide (¹²⁴Te) TeO₂ is prepared as follows: combined stoichiometric amounts of enriched powdered (¹²⁴Te) TeO₂ and 6.7% in weight of Al₂O₃ placed evenly into target depression and heat at different temperature gradients.

Enriched Tellurium dioxide comes from ISOFLEX, San Francisco, Calif., USA and Aluminum oxide comes from Sigma-Aldrich, 1001 West St-Paul Avenue, Milwaukee, Wis. 53233 or equivalent.

The process of thermal distillation is complete when the activity monitor located where the activity deposits on the quartz tube reads a predetermined high value. Also from multiple runs, it was noticed that about 90 minutes heating from room temperature to about 1080° C. gave a recovery of about 90% off a round disk target.

In an aspect a round (substantially round) disk is obtained from ESPI Metals (Electronic Space Products International), 1050 Benson Way, Ashland, OR, USA and the inclined target is obtained from Newton Scientific, Inc (NSI), 255 Bent Street, Cambridge, Mass., USA. Newton Scientific, Inc. or equivalents.

In an aspect an illustrative suitably configured disk is shown as a round disk about 0.750″ diameter×0.0625″ thickness with a centered depression o.d. (outside diameter) of 0.25″ diameter×0.040″ depression. In an aspect the inclined target has in its 20° inclination an elliptical depression of surface area 0.26″×0.88″. Other effective configurations of a disk may be employed which facilitate the process of this discovery. (″ means inches).

In an aspect the bombardment of the target is carried out by directing nuclear particles such as protons to the target using a charged particle accelerator to produce a nuclear reaction. Useful nonlimiting charged particle accelerators include biomedical cyclotrons and linear accelerators. A typical useful charged particle accelerator is a large commercially available device to induce nuclear reactions using electric fields to accelerate charged particles.

In the case of a rounded (flat circular) disk target, the powdered [^{76 or 77}Se]Cu₂Se or [¹²⁴Te]Cu₂Te target material is pressed hydraulically under about one metric ton to about two metric tons pressure producing a pressed material suitably adherent to the round disk. The pressed material is then gradually heated, in a high temperature furnace, near the melting point temperature of the pressed material. This melting point is about 1113° C. for bromine and about 1133° C. for Iodine.

In the case of powdered combined Tellurium dioxide (¹²⁴Te) TeO₂ and aluminum oxide Al₂O₃ is evenly spread into the target depression. The material is then gradually heated at different temperatures, in a high temperature furnace, for about five hours, and cool overnight. Al₂O₃ is added to increase the adherence of the layer to the target substrate.

For the inclined target, an appropriate amount of powdered material is placed in the depression of the target (serves as a target substrate) and is evenly spread over the surface of the target. The target is then gradually heated, in a high temperature furnace, near its melting point temperature. This allows a good adherence of the heated powdered material onto its tungsten substrate. The typical thicknesses obtained are approximately 200 mg/cm² for disk targets and 100 mg/cm² for inclined targets. The effective thickness is the thickness presented to the beam of protons directed to and impacting on the target. In an aspect the powdered material is converted to a solid by the applied heat of the high temperature furnace. In an aspect, the depression if effectively configured to accept the powdered material to be placed therein and to release the same upon contact with effective thermal distillation.

⁷⁶Br, ⁷⁷Br and ¹²⁴I radionuclides are produced via the (p,n) reaction on enriched ^{[76,77]}Cu₂Se or enriched ^{[124]}Cu₂Te targets using 14.5 MeV protons as disclosed in the published work of Tolmachev V. et al. (Tolmachev V., et al. Appl Radiat. Isot. Vol 49 No. 12, pp 1537-1540 Elsiever Science Ltd. 1998). In an aspect the target powdered material is melted into a depression of tungsten disk. The disks are bombarded in a windowless configuration and are water-cooled from the back. For irradiations using the disk target, beam intensities up to 5 μA for ^{76,77}Br and ¹²⁴I production can be tolerated without degradation in the structure of the target material and are effective to satisfactorily irradiate the powdered material thereon. For irradiations using the inclined target, the melted target material for ^{76,77}Br and ¹²⁴I production is bombarded with beam currents up to 20 μA without any degradation in the structure of the target material. ¹²⁴I is also produced as disclosed in the published work of Sheh Y. et al. (Sheh Y. et al. Radiochim Acta. 2000; 88: 169-173) using combined stoichiometric mixture ¹²⁴TeO₂*Al₂O₃. ¹²⁴I is also available commercially.

The target is held by a target holder comprising a tantalum spoon during preparation and separation operation at high temperature environment. In an aspect the ⁷⁶Br, ⁷⁷Br or ¹²⁴I activity is carried through the process by an inert gas stream (such as Argon). ⁷⁶Br or ⁷⁷Br is trapped on the inner wall of the quartz tube (smaller diameter side). The deposited ⁷⁶Br or ⁷⁷Br activity is recovered by rinsing the wall with NH₄OH and is passed through a Sep-Pak purifying cartridge. The target is receptive to the nuclear bombardment. As for ¹²⁴I it is trapped on a loop cooled with dry ice and located at the end of the quartz tube. ¹²⁴I activity is recovered by rinsing the loop with NH₄OH and is passed through a Sep-Pak purifying cartridge. The target holder can be of any high purity material that has the following properties: a high melting point of above 1300° C., a good thermal conductivity, non reactive at high temperature and wear resistant.

In an aspect, effective recovery of radiohalogen ⁷⁶Br, ⁷⁷Br or ¹²⁴I is carried out in a high temperature furnace at temperature above about 1050° C. under a constant stream of argon gas or equivalent. In an aspect the furnace is turned on once the irradiated target is introduced in the furnace. The furnace starting or initial temperature is about room temperature (about 20° C.) and it takes between 30 to about 40 minutes to preheat; and about 50 minutes to reach the desired high temperature thus a total of about 90 minutes for the thermal distillation.

After irradiation of powdered [^{76 or 77}Se]Cu₂Se or [¹²⁴Te]Cu₂Te, the irradiated target is placed face-up in a quartz tube in the center of the furnace.

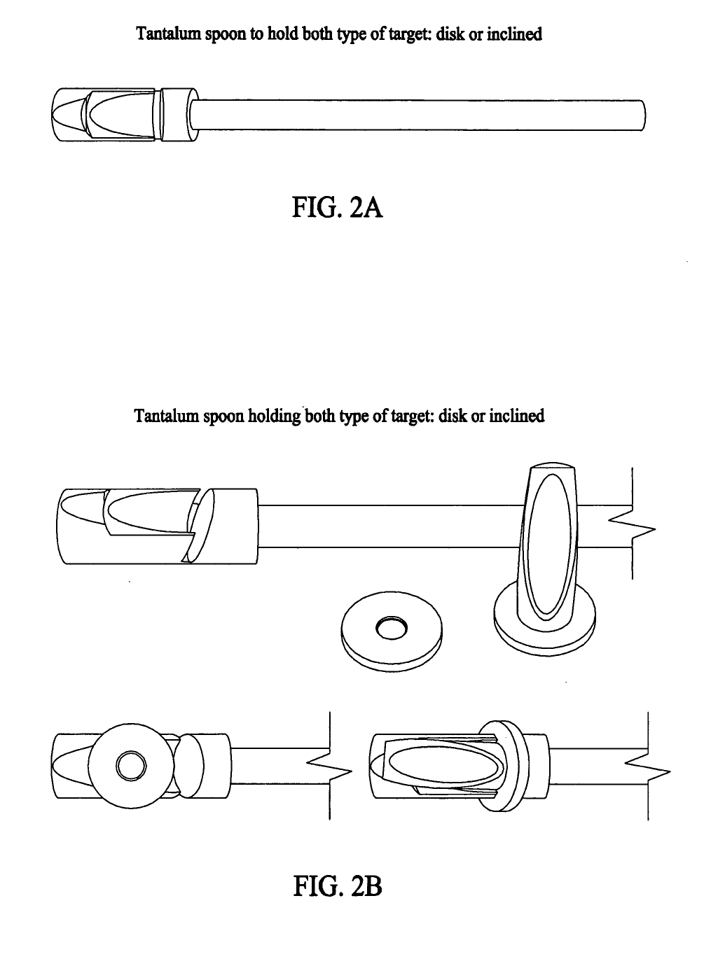

In an aspect, a tantalum spoon is used as a holding device to hold the target and to introduce and position the target into the quartz tube. Releasable product halogen activity is released from the target upon being heated in the thermal distillation of the radioactive target. In an aspect a suitable tantalum spoon is prepared from a tantalum rod by a metal working operation according to the drawings here in (see FIGS. 2A, 2B and 2C).

The halogen radioactivity released by the thermal distillation is carried through the system by an argon gas (inert gas) stream which picks up the halogen radioactivity released to the argon gas stream by thermal distillation of the target.

The argon gas stream or equivalent is routed to a NH₄OH trap, which also has a charcoal filter. The halogen activity is released from the argon gas stream or equivalent and is deposited in the quartz tube wall just outside the furnace, at the smaller diameter side for ⁷⁶Br and ⁷⁷Br, and in the cooled loop located after the smaller diameter side of the quartz tube for ¹²⁴I. Using a solenoid operated 4-way valve, ammonium hydroxide is introduced into the quartz tube or loop to rinse the recoverable activity off the quartz tube or loop and thus acquire the releasable halogen activity from the target.

Ammonium hydroxide (NH₄OH) aqueous liquid rinse (0.1 N to 2 N for ¹²⁴I and 6N for ⁷⁶⁻⁷⁷Br) containing the halogen activity is then re-directed using the same solenoid operated 4-way valve into a suitable collection container or collection vial. This liquid rinse is applied a total of three times into the quartz tube wall or loop to rinse the recoverable activity off the quartz tube or loop and to effectively induce releasable radioactivity. In an option multiple ammonium hydroxide liquid rinses may be applied into the quartz tube or loop to rinse the recoverable activity off the quartz tube wall or loop to remove additional releasable halogen radioactivity into the liquid ammonium hydroxide liquid rinse.

The recovered individual ⁷⁶ Br, ⁷⁷ Br and ¹²⁴I respective halogen activity is in less than 1-ml of dilute NH₄OH. Then using a 3-way solenoid valve and an empty syringe to pressurize the collection vial, the recovered activity into NH₄OH is passed through a Sep-Pak cartridge or equivalent. (Sep-Pak® cartridge comprising a cartridge containing a silica-based bonded phase with strong hydrophobicity available from Waters, 34 Maple Street, Milford, MA. 01757 USA. Sep-Pak® is a registered trademark of Waters.) The eluant coming out of the Sep-Pak cartridge is purified and contains the desired radioactivity. It is collected into a final syringe for distribution and use to prepare a pharmacologically acceptable halogenated ligand compound.

To optimize the total production for ^{76,77}Br and ¹²⁴I, a slanted target is used to allow larger currents to be applied to the target (increasing the beam current from ˜5 μA to 20 μA). However, this type of target does not permit pellet formation through the method of pressing the target material during the preparation process. Consequently in an aspect a 1300° C. tubular furnace is employed to satisfactorily melt the target material onto the slanted target. The melting point of Cu₂Se is reported to be 1113° C.

The inventors' testing of Cu₂Te with the high temperature furnace showed and is evidence that a physical change in the initially deposited precursor Cu₂Te was noticed at 1133° C. The prepared Cu₂Te target was irradiated for 10 min. at 5, 10, 15, and 20 μA and good stability of the target material was observed. In an aspect, the 1300° C. tubular furnace is dual function as it can serve dual purposes, as a heating system for preparation of target material on the slanted target and as a thermal distillation unit of the irradiated target to induce release of produced halogen radionuclides into an argon gas inert stream contacting the irradiated target.

The 1300° C. Tubular Furnace was obtained from The Mellen Company, Inc., 40 Chenell Drive, Concord, NH, USA. The Series TT13 furnace is configured with one control (hot) zone 1.5″ diameter×2″ long at its center. The furnace utilizes the Mellen Series 13T heater which is engineered with large cross-section Fe—Cr—Al elements to maximize heat transfer and minimize thermal distortion. The furnace's insulation package consists of high grade alumina-based insulation. The insulation is contained in all stainless steel housing. A 3/16″ I.D. ceramic-lined thermocouple port for a ⅛″ diameter ceramic sheathed thermocouple is supplied in the center of the control zone. A 2.5″ long vestibule with a 1.5″ hole is supplied at each end of the furnace.

A Mellen Series PS400 temperature control system is used to monitor the furnace temperature using a three-mode control action PID (Proportional, Integral, Derivative) programmed into the PS400 to keep the temperature at a setpoint value. A type “S” Pt/Pt-10% Rh thermocouple is located at the center of the control zone and is electrically communicative with the Mellen Series PS400 temperature control system.

An over-temperature alarm for furnace protection utilizes an independent controller. A type “S” Pt/Pt-10% Rh thermocouple is located at the center of the control zone next to the temperature control thermocouple. Sufficient mechanical power contactors are supplied to interrupt power to the furnace in the event of an over-temperature condition at the location of the over-temperature sensor.

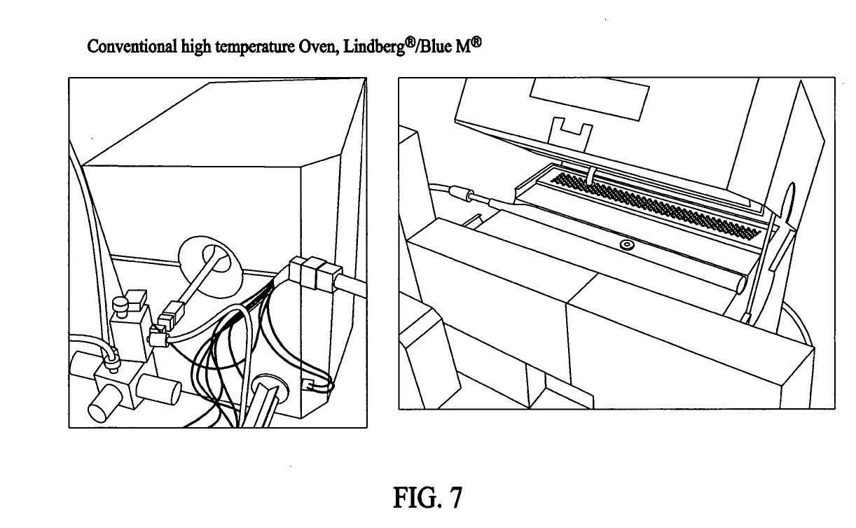

In another aspect ⁷⁶Br is produced from thermal distillation from a disk target using a conventional high temperature oven (FIG. 7). An irradiated target is placed in a quartz tube inside the high temperature oven under argon gas atmosphere or equivalent and the high temperature oven is heated to about 1100° C. for approximately 1 hour. The ⁷⁶Br or ⁷⁷Br activity is deposited on about 4 cm at one end of the quartz tube wall located outside of the oven and in the cooled loop located after the smaller diameter side of the quartz tube for 124, and is recovered with several 0.6N ammonium hydroxide NH₄OH rinses. The NH₄OH (aqueous ammonium hydroxide) rinse solution is transferred using tubing and 3-way and 4-way solenoid valves.

In an aspect a remote procedure using automated solenoid valves is used to prepare ⁷⁶Br, ⁷⁷Br and ¹²⁴I and minimize absorbed radiation doses to personnel. This automatic system uses suitably configured automatically controlled valves to distribute gas and liquid at different locations during distillation and recovery of ⁷⁶ Br, ⁷⁷Br and ¹²⁴I.

In an aspect the radioactivity remains inside a hotcell protection system reducing exposure to an equipment operator. In an aspect, a device is designed to slide the irradiated target in the quartz tube and seal the system during the distillation step (FIG. 2). The separation in this aspect will follow using substantially the same procedure as the aforedescribed existing remote system with the valves. The 1300° C. tubular furnace will be used for the automation and everything will be placed in a hotcell of dimensions of about 71 cm Long×about 53 cm High×about 46 cm Wide.

FIGS. 2A, 2B and 2C show an illustrative tantalum spoon useful to introduce target material to be melted on a disk or inclined target and also use to introduce the irradiated targets. The tantalum spoon comprises tantalum metal which is a material having a high melting point (2996° C.), a good thermal conductivity (0.575W/cm K), a non reactivity at high temperature, a high strength and wear resistant. Tantalum is a gray, heavy hard metal and is available in many suitable forms including foil, sheet, wire, insulated wire, powder, mesh and rod. In an aspect the tantalum spoon was prepared from a tantalum rod in a metal working operation.

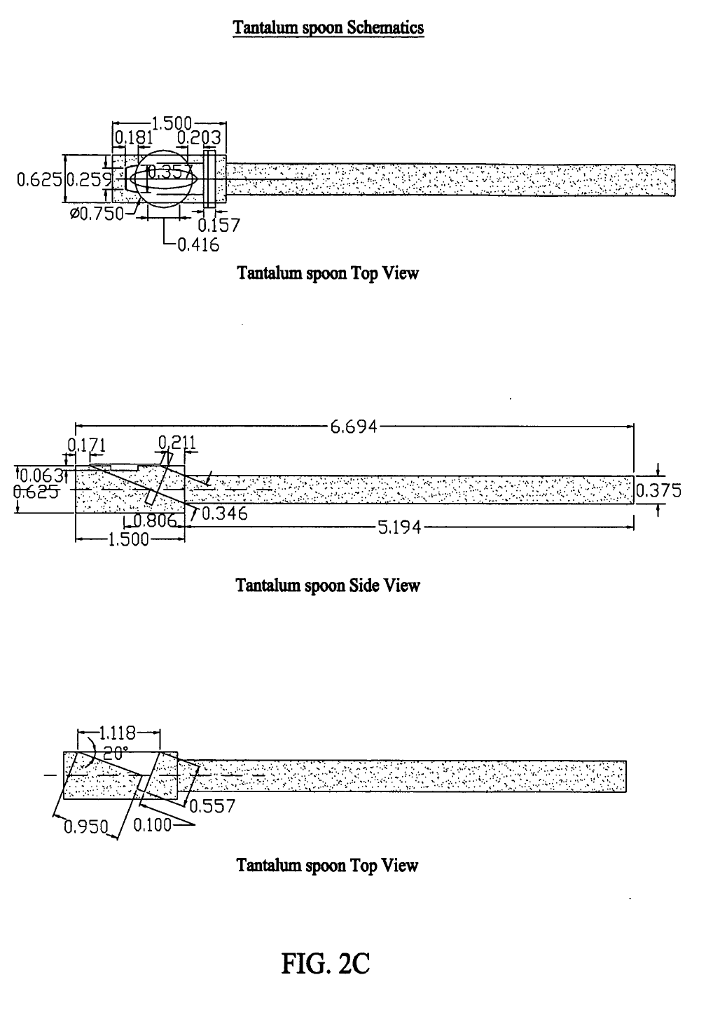

FIG. 3 shows the Mellen 1300° C. Tubular Furnace used during preparation of target material to melt the target material on a disk or inclined target and also for thermal distillation of the irradiated targets. The Mellen 1300° C. tubular Furnace contains insulation to permit the best possible thermal delivery operation. The furnace can be positioned vertically or horizontally to accommodate any space. The Mellen furnace is equipped with a temperature control system which uses a thermocouple of type S to measure temperature in the furnace. The furnace is also equipped with an over-temperature alarm for furnace protection which shut off the furnace power in the event of a high alarm temperature or other present alarm process condition or when the furnace heat is not needed.

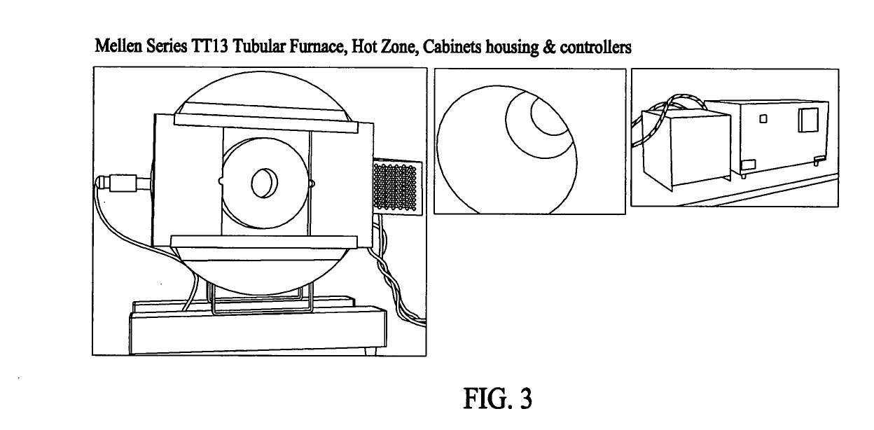

FIG. 4 shows the quartz tube use during preparation of target material, thermal distillation of irradiated targets and recovery of activity. In an aspect, a useful quartz tube is made to custom specifications form Quartz Scientific, Inc. (QSI), 819 East Street, Fairport, Harbor, OH, USA). The specifications are about 28 mm I.D.×31 mm O.D.×176 mm long reduced to 4 mm I.D.×6.36 mm O.D.×94 mm long. (I.D.=inside diameter, O.D. means outside diameter).

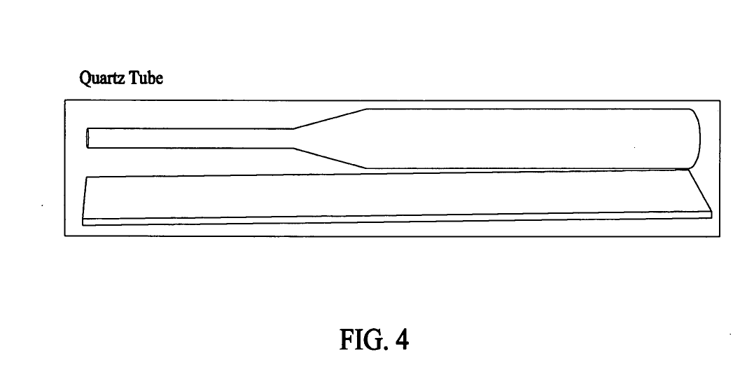

FIG. 5 shows a 4-way solenoid operated valve (Bio Chem Valve, Inc., Series 080T) Bio-Chem Valve Inc., 85 Fulton Street, Boonton, NJ 07005 used to introduce the solvent rinse and to recover the activity in the collection vial. The 4-way solenoid operated valve has 3 inlets and 1 common outlet port. It has the following reported specifications: 12 VDC voltage, 0.22 Amps current, operating pressure at common port: vacuum to 35 psi and inlet port: vacuum to 20 psi, the body material is made of Teflon® material (Teflon® is a registered trademark of DuPont Co., Wilmington, Del., USA).

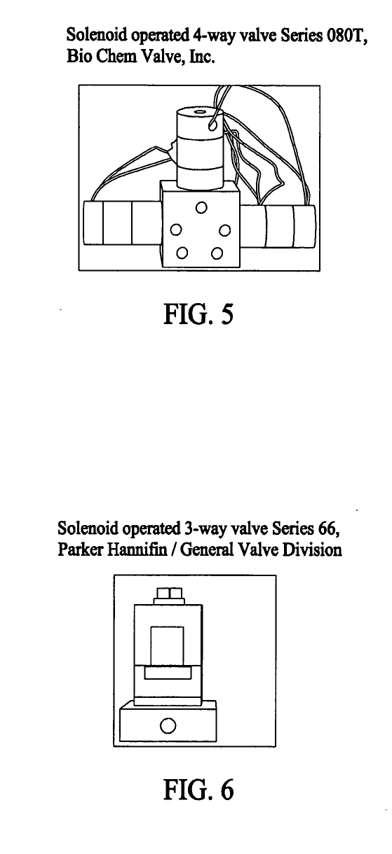

FIG. 6 shows 3-way valve solenoid operated valve (Parker Hannifin/General Valve, Series 66, General Valve, 19 Gloria Lane, Fairfield, NJ 07004) used to pressurize the collection vial to load the radioactivity onto a C₁₈SepPak® Cartridge and then into an empty syringe. The 3-way valve solenoid operated valve as 2 inlets and common outlet port. It has the following reported specifications: 12 VDC voltage, 286 mA current, operating pressure: vacuum to 30 psi, all plastic and elastomeric construction, media contacting material is made of PEEK (Poly Ether Ether Ketone) material and Ethylene Propylene seal.

The process outlined herein is for illustration purposes only and no dimension provided herein is deemed to be limiting in any way. It is understood that appropriate size valves, solenoids, piping and various process connections providing operability will be made after reading this specification, claims and drawings.

In an aspect, the ⁷⁶Br, ⁷⁷Br and ¹²⁴I recovery unit is programmed to operate a process scheme shown in Table I following the schematic of FIG. 1.

In an aspect the halogen process is automated according to Table I attached (Control Sequence for Automated Control). A preferred sequence for the automated control of solenoid valves and syringes shown in FIG. 1 is shown in Table 1 and detailed more particularly herein and below.

Table I provides this illustrative control sequence as a listing of numbered steps in the left hand column more particularly identified in another companion adjacent column which recites a function of the step. Valves are numbered 1-10 shown in Table I and correspond to valves shown in FIG. 1 of the process schematic for the separation and purification unit. Syringes 27, 32, 38 and 39 are shown (as read in a normal reading position) in the right hand column with the upward pointing arrows “↑” indicating pulling syringe(s) plunger and the downward pointing arrows “↓” indicating pushing the syringe(s) plunger. In this control sequence for an automated operative method of recovering ⁷⁶Br, ⁷⁷Br and ¹²⁴I steps are associated with valves and syringes according to recited elements of a row of the Table 1.

As applied to the syringes in Table 2, alphabetical letters “x” and “o” are convenient symbols with “o” schematically representative of an open position of a valve (flow permitted therethrough as valve is in an open position) and “x” a symbol schematically representative of a closed valve (no flow permitted therethrough as valve is in a closed position.).

The abbreviation vac. means vacuum. As applied to vacuum, “o” means On which means vacuum is being applied and “x” means Off which means vacuum is not being applied.

Useful syringes are available commercially such as Monoject types (manufacturers: Becton-Dickinson, 1 Becton Drive, Franklin Lakes, NJ, USA 07417 or Sherwood or can be purchased from distributors such as Fisher Scientific, USA or Midwest Medical, USA).

FIGS. 5A, 5B, 5C and 5D show an illustrative syringe holder dimensional schematic useful herein.

In an aspect automation of automated process is accomplished by utilizing an electronic control system wherein a computer program is written and utilized to instruct timers, counters, and motion controllers to a specific sequence. Typically the program provides analog signals and analog outputs wherein such analog signals and such analog outputs are used to instruct the valve sequence and to monitor activity throughout processing.

It is understood that automatic control system(s) are employed which have been operably loaded with effective functional software, coupled through electrical mechanical servo-mechanisms directed by the software commands to actuate 3-way and 4-way solenoid valves on respective units were employed to carry out automated operation of the unit. It is further understood that a functioning operationally capable computer may be suitably employed in this automatic control system having sufficient memory to carry out the software commands loaded into it and being suitably connected to solenoids through a cooperative and capable operating network using the control sequences herein provided.

As used herein the term “solenoid valve” includes the Parker's Hannifin Corporation solenoid valve line, USA. These valves are used to direct the flow of supply air and solvent into different locations in the process such as the valves described herein and the uses described herein. The valves come equipped with a variety of seal materials, electrical enclosures, and power ratings suitable for use in the discovery herein described and claimed. In an aspect solenoid valves are electromechanical devices that utilize a solenoid to control valve activation; this also includes Parkers Gold ring solenoid valves and Graingers solenoid valves and associated functional communicative equipment.

As used herein the terms “automate” and “automated” mean as applied to a process, a conversion to automation and to use the techniques of automation, i.e. automated teaching. The terms “automated” include a system or method in which many or all of the processes of production and movement and control (including the individual processes of separation, recovery and purification or any combination of those processes) are automatically controlled by self operating electronic, mechanical or electromechanical functional and functioning means. Such automation may be accomplished by the appropriate use of one or more computer or instructional units providing the implementing instruction to the process equipment. In an aspect to automate includes to operate or control by using a functioning computer or software equipped control system such as a computer or instruction unit configurably functionally loaded with a control sequence such as shown in Table I, Table II or Table I and Table II herein as instructions and suitable software interfaced with solenoid valves and syringes. In another aspect a functioning computer or software equipped instructional control system is electronically coupled to a solenoid valve and/or syringe which is controllable by electronic or pneumatic signal. In an aspect transducers are employed to provide means of effective communication between the instruction unit and the valves and/or syringes.

In an aspect solenoid valves includes electromechanical devices that use a solenoid to control valve actuation. Electrical current such as that from a computer or electrical instructional unit is configurably and operably supplied to the solenoid coil of the solenoid valve. A resulting magnetic field acts upon a plunger, whose resulting motion actuates its associated valve. Like computers solenoid valves are activated by supplying electrical power to the solenoid.

In an aspect there is herein described the capability functions of the software for operating the automated process. The functions include those for operating the computer, the software and for communication but also those illustrated in the Examples and in the specification, claims and drawings including valve sequences for operations including timing of valve positions, sequencing of valves, cycling of valves and the like. The functions of the software herein presented provide those of skill in the art after reading the specification and claims the ability to make and use this discovery.

This specification and claims describes an illustrated computer or computer component implemented in either hardware or software and its associated hardware platform. The use of a computer is satisfied with at least one of—a programmed computer with a particular functionality implemented in hardware or hardware and software—a logic circuit or other component of a programmed computer that performs a series of specifically identified operations dictated by a computer program; and/or—a computer memory encoded with executable instructions representing a computer program that can cause a computer to function in a particular fashion.

As used herein, the term “syringe” is representative of an injection member.

The term “valves” as used herein includes any flow control apparatus which is configurably designed to maintain, restrict, or meter the flow of materials through pipes, hoses, tubing or entire systems. Valves typically allow flow in their open position and when closed restrict or shutoff flow.

Example of valve sequence: The 4-way valve is a 2-way NC standard. It has a COM port with 3 inlets. The 3-way valves are 3 way configurations. They each have a COM port, a NC port and NO port. (NC, Normally Close; NO, Normally Open; COM, Common).

Example of valve sequence for step 4 (Recover activity 1 in vessel) in Table 1:

To recover the first solvent rinse, energize the 4-way valve so that ports 1 (COM) and 4 are NO and ports 2 and 3 are NC. Also, energize the 3-way valve so that port 8 is NO while port 9 is the COM and port 10 is NC. The other 3-way valve is de-energized, with the following configuration: port 5 NO, port 7 NC and port 6 COM. With syringe 32 on port 5 (NO), pressurize recovery vessel 30 (port 6 COM) until solvent rinse 1 passes through ports 1 (COM) and 4 (NO) and is recovered in recovery vessel 30.

As used herein the term “PD control” includes an algorithm used for the control process control loops in the process of this discovery. PID is useful for this basis advanced control algorithm. One would tune the PID to this discovery.

As used herein, the term “PID” means respectively proportional, integral and derivative. The starting point is setpoint value which is the point, place or status where the human operator would like the controlled variable or process to be. We then determine error which is the difference between desired set-point and measurement. This can be expressed mathematically as (error)=(setpoint)−(measurement). The variable being adjusted is called the manipulated variable which usually is equal to the output of the controller.

The output of functioning PID controllers will change in response to a change in measurement or set-point according to modes of the controller. Modes are denoted as: proportional band (P) referred to sometimes as gain, the reciprocal of proportional band and defined as 100/gain (% units), I; integral a function which adjusts the controlled variable to setpoint after the system being controlled stabilizes and can be defined as one/reset and D and derivative which senses the rise or fall of the system variable and automatically adjusts P to minimize variation and is also known as is rate which is also re-act (units are of time) Integral and reset are the same and are in time/repeat or repeat/time with integral being the reciprocal of reset and vice versa. (Derivative and rate are the same).

Illustrative useful process and temperature control product lines include those of West Instrument, LFE, Watlow and Gentran, USA.

Thus applicants have discovered and disclosed how to configure a computer to possess the requisite functionality and how to successfully operably integrate the programmed computer with other elements of this discovery.

At the end of the automated processing a purified nuclide (⁷⁶Br, ⁷⁷Br and ¹²⁴I is ready for labeling with compounds used for the detection of certain proliferative cancers. Then the labeled compound is purified and made into an injectable form. All processing and chemistry are scheduled according to the time of use or injection for PET studies for example.

At the end of the automated processing a purified nuclide (⁷⁶Br, ⁷⁷Br and ¹²⁴I) is contained within a Norm-Ject® syringe which is shielded until chemistry processing.

The purified product nuclide is recovered from the automated process producing that purified product nuclide and readied for use in diagnostic imagining as is described herein which in an aspect includes the use of the purified product nuclide in a pharmaceutical composition which is effectively administered to a patient such as a living mammal such as a human.

In an aspect ⁷⁶Br, ⁷⁷Br and ¹²⁴I compound is systematically administered, e.g., orally, in combination with a pharmaceutically acceptable vehicle or attached as a ligand to another pharmacologically acceptable compound such as an inert diluent or an assimilable mammalian edible carrier to the patient. The ⁷⁶Br, ⁷⁷Br and ¹²⁴I may be enclosed in a gelatin capsule, may be compressed into a tablet, may be in soluble form for direct injection into the patient, or may be a part of the patient's diet. The ⁷⁶Br, ⁷⁷Br and ¹²⁴I labeled compound may be combined with one or more compatible functional excipients and administered as ingestible tablets, buccal tablets, etc. In an aspect the selected administration is, orally or parenterally, by intravenous, intramuscular, topical or subcutaneous routes of effective administration.

In an aspect the unit performs the labeling of the recovered radioactivity with an appropriate ligand or biomolecule. The ligands as such is designed that complexation between the halogen nuclide of choice and the ligand produces a halogen-labeled compound that will have pharmacological distribution suitable for the effective diagnosis or treatment of disease in living mammals or biologic samples thereof.

Pharmaceutical compositions may be used such as those formulated using readily available formulation ingredients with one or more novel radionuclide compounds. In an aspect at least one novel compound is incorporated, optionally together with other active substances, with one or more conventional pharmacological acceptable carriers, diluents and/or excipients, to produce a conventional preparation(s).

In an aspect a pharmaceutically acceptable salt includes any water soluble salt which is pharmaceutically suitable to the mammalian recipient of a radiolabeled compound. In an aspect a pharmaceutically acceptable diluent or carrier includes an aqueous diluent or any diluent or carrier which is innocuous to the mammal recipient of a radiolabeled compound and which provides for facilitation of the administration of radiolabeled compound(s) and their radionuclide counterparts.

The precise dosage of the detectably radiolabeled compound to be administered and the length of time over which administration is carried out will depend on a number of factors including the age and weight of the mammal patient and the route of administration.

In an aspect a therapeutic rate titration is performed wherein the living mammalian afflicted with cancer or believing to be so afflicted with cancer is administered a series of dosages and respective effects therefrom or thereafter are determined by an inventive method herein at respective dosages and times. In this manner a therapeutic dosage curve or titration is obtained for determining dosage for that mammal patient.

In an aspect, the radionuclide is purified.

Administration may be performed by local or systemic application as appropriate. Administration of compositions may be done by inhalation, orally, rectally or parenterally, such as by intramuscular, subcutaneous, intraarticular, intracranial, intradermal, intraocular, intraperitoneal, intrathecal and intravenous injection. The injection may be by stereotaxic injection. Local administration may also be performed, e.g. at an affected site e.g. by use of a catheter or syringe. Treatment by topical application of a composition, e.g. an ointment, to the skin is appropriate. Administration may be performed at intervals of time, such as two or more applications, at some intervals, such as several times a day, or at periodic intervals of the daily or daily.

PET, or Positron Emission Tomography is a non-invasive molecular diagnostic imaging (standard) medical procedure that produces (i.e. capture and optionally record) multiple acquisitions i.e. images of the body's biological functions and in an aspect are used to determine the extent of malignant disease. In an aspect, these imaging procedures show the presence and distribution of a radiolabeled detectable functionally emitting radiolabeled chemical i.e. a radionuclide acquisitioned at various selected times. Advantageously these imaging procedures depict metabolic characteristics of tissues and changes therein.

In an aspect, positive emission tomography (PET imaging) comprises detection of y-rays emitted from ⁷⁶Br, ⁷⁷Br and ¹²⁴I radionuclides that decay by positron emission and are located within a mammalian patient's body. In an aspect this is possible by virtue of administration of a radiolabeled halogen compound to that patient.

In an aspect an external measurement is made of the two high energy photons emitted in opposite directions when a positron-emitting radionuclide decays in the patient. A large number of scintillation detectors detect these photon pairs and measure the sum of radioactivity along many different paths through the patient undergoing measurement. Appropriate software associated with the instrument reconstructs a three-dimensional image of the patient and the concentrations of ⁷⁶Br, ⁷⁷Br and ¹²⁴I radionuclides can be expressed in quantitative units of radiotracer concentration per ml of tissue.

In an aspect images are taken over elapsed time in dynamic fashion to assemble a developing or developed scenario of situations in the mammalian patient. The location of the radioactivity detected by the detector is indicative of the location of disease for a given radiopharmaceutical. A PET image is taken (i.e. acquired) of a mammal after administration of a compound to the mammal.

In an aspect a radioactive bromine or iodine substance is produced in a process and is attached, or tagged, to a compound forming a radiopharmaceutical. Once this attached substance is administered to a patient, the radioactivity travels through the tract or the vascular system of the body and localizes in the appropriate areas of the body being treated and is detected by PET scanner. In an aspect administration to the patient such as to a living human patient is carried out by administering the human an aqueous composition comprising a water soluble salt composition of a radioactive compound.

A hot cell is a closed work area in which radioactive materials may be manipulated without exposing the operator to gamma radiation. Some cells are dedicated to the production of a single radioisotope in order to minimize contamination. Other cells are used to process a wide range of isotopes while still others are used for storage and transfer functions. They are an integral part of radioactive isotope production and their care and maintenance are high priorities. If desired the tagging, purification, separation may be done in such a hot cell. It is desired to produce a chemical which is stable and emits radioactivity from the radionuclide and useful in this discovery.

It is understood after reading the specification and claims that one practicing this discovery in a radioactive environment will use all necessary and practical safety protective equipment including the use of all personal radioactive protection gear.

MicroPet is also useful in this diagnostic imaging (MicroPET® is a dedicated PET scanner designed for high resolution imaging of small laboratory animals. It is available from Concorde Microsystems, Inc. 10427 Cogdill Rd, Suite 500 Knoxyille, TN 37932 USA.). Other manufacturers also offers other small animal scanner for example Mosaic® from Phillips.

In an aspect positron emission tomography PET is an external measurement made of the two high energy photons emitted in opposite directions when a positron-emitting radionuclide decays in a patient. A large number of scintillation detectors detect these photon pairs and measure the sum of radioactivity along many different paths through the patient undergoing measurement. Appropriate software associated with the operating instrument reconstructs a three-dimensional image of the patient and the concentrations of radionuclides can be expressed in quantitative units of radiotracer concentration per ml of tissue.

In an aspect a PET image is taken of a living mammal after administration of a cancer or tumor detector compound to a living mammal but not limited to this type of disease. The image may be retained in computer storage if desired. A number of images may be acquired as a function of elapsed time to produce a profile over time of the images.

In an aspect the compound with its radionuclide is administered to the patient as an aqueous composition such as a saline composition to the living animal such as to a human. Typically the compound and its radionuclide will be formulated as a water soluble salt and administered in an aqueous formulation comprising that water soluble salt of the compound and its radionuclide.

In an aspect a radioactive substance is produced in a process and after recovery therefrom is attached, or tagged, to a tracer compound to as radiolabeling.

In an aspect ⁷⁶Br, ⁷⁷Br and ¹²⁴I are isolated and recovered as products of this discovery for further use such as in a radiolabel tracer compound. In an aspect the automated system is electrically/pneumatically communicatively configured capable and functional in all operationally necessary aspects.

Typically an adequate amount of time is allowed to lapse for the treated living mammal (i.e. having received the radiolabeled benzamide) to come to an equilibrium state following satisfactory administration of the benzamide radioligand to the mammal. Typically the mammal is placed in a position near the PET instrument or microPET® instrument allowing satisfactory operation of the PET instruments. The PET instruments are equipped with all necessary operable software and operation requirements.

Generally after mammal has received its administration of the radiopharmaceutical containing ^{76,77}Br or ¹²⁴I the mammal is placed in/on the PET scanner, which has a opening in the middle. In the PET scanner there are multiple rings of detectors that record the emission of energy from the radioactive substance now within in the mammal. In an aspect the mammal is comfortably moved into the hole of the machine. The images are displayed on the monitor of a computer, suitably equipped and operably coupled to the PET scanner instrument for acquiring. In an aspect the image of emitted radioactivity of the mammal provides a location for the disease in that mammalian patient with the theory being that the radioactive material being retained by the mammal indicates the presence and location of the disease in the mammal that has received the ⁷⁶Br, ⁷⁷Br and ¹²⁴I radiolabeled copper compound.

In an aspect an internal radiation cancer therapy useful on living mammals comprising administering anti-cancer compounds synthetically labeled with automatically prepared purified ⁷⁶Br, ⁷⁷Br and ¹²⁴I to such living mammals. In an aspect a treatment of malignant neoplasm in living mammals (human and nonhuman) comprises administering anti-cancer compounds ligated with purified ⁷⁶Br, ⁷⁷Br and ¹²⁴I labeled compounds.

In an aspect, a method for diagnosing a human mammal for the presence of a disease comprises administering to the mammal a diagnostic imaging detectable effective amount of a purified ⁷⁶Br, ⁷⁷Br and ¹²⁴I labeled compound, detecting binding or internalization of the at least one highly purified ⁷⁶Br, ⁷⁷Br and ¹²⁴I labeled compound to a disease in the mammal. In an aspect the method further comprises determining that a mammalian disease is present in the mammal being administered by detecting such binding or internalization, thus diagnosing the mammal. In an aspect the method comprises producing an acquisition of the detection of disease in the administered to mammal. In an aspect detection of emitted radioactivity indicates the presence of and location of disease in the mammal being diagnosed.

In an aspect, a novel pharmaceutical composition comprises a novel purified ⁷⁶Br, ⁷⁷Br and ¹²⁴I labeled compound prepared by the process of this discovery and a pharmaceutically acceptable diluent or carrier.

In an aspect the pharmaceutical composition comprises a purified tracer compound with an emitting radiolabel and optionally a suitable adjuvant such as a surfactant which is pharmacologically acceptable to the patient such as to a living mammal such as a human.

In an aspect, a method to determine the presence of a disease in a living mammal comprises administering to a living mammal afflicted with a disease, an effective amount of a purified ⁷⁶Br, ⁷⁷Br and ¹²⁴I labeled compound and determining the extent to which the detectably-labeled radiohalogen compound binds to cells of a disease in the treated mammal. In an aspect the living mammal is nonhuman.

In an aspect, a method for diagnostic imaging of a mammalian tissue comprises administering to the tissue of the mammal a diagnostic imaging amount of purified ⁷⁶Br, ⁷⁷Br and ¹²⁴I labeled compound comprising a detectable amount of ⁷⁶Br, ⁷⁷Br and ¹²⁴I and detecting an image of that tissue. In an aspect the living mammal is nonhuman. In an aspect, the image is used to diagnose status of mammalian tissue.

Those of skill in the art will recognize that process conditions, reactions and operating setup will be apparent to one of skill in the art after reading this specification and claims and drawings such that the process will be setup and operated such to make it operable and to achieve its intended purpose. It is understood that software, hardware, valves, connectors and connections are fully communicative and operable and operationally enabled in accordance with this discovery.

Illustrative Materials Used

Concentrated NH₄OH, ACS 28.0-30.0% (Alfa Aesar # 33285) or equivalent
Ethanol, 200 proof (Aaper #92402 supplied by Washington University Medical School) or equivalent
Argon gas (Distributor: CeeKay Supply Inc #AR5100 grade 4.8) or equivalent
⁶³Cu metal, 99.8% enriched (Isoflex USA) or equivalent
⁷⁶Se elemental, 99.80% enriched (Isoflex USA) or equivalent
⁷⁷Se elemental, 99.0% enriched (Isoflex USA) or equivalent
¹²⁴Te metal, 99.80% enriched (Isoflex USA) or equivalent
¹²⁴Te oxide, 99.80% enriched (Isoflex USA) or equivalent
Aluminum oxide, Al₂O₃, activated neutral 150 mesh (Sigma Aldrich # 199974-5G) or equivalent
1300 deg C. Tubular Furnace (1.5×2 (1 zone) high T furnace) (Mellen Company #TT13-1.5x2-1Z) or equivalent
3-way solenoid valve system (Parker Han nifin Corp., Model # 066-0036-901) or equivalent
4-way solenoid valve system (Bio-Chem Valve Inc., Model # 080-T3-24-62) or equivalent
Sep-Pak C-18 filter cartridge (Waters # WAT023501) or equivalent
PTFE Tubing, 1/8 inch OD, 1/16 inch ID (Cole-Parmer # A-96000-02) or equivalent
24 inch plastic tubing, 1/8 inch OD, 1/16 inch ID with male-female ends (Cole-Parmer part # 30600-65) or equivalent
Syringes (Norm-Ject®) (Air-Tite Products Co, Inc.) or equivalent
Quartz tube (Quartz Scientific # 317RT028C295) or equivalent
Airfree adjustable bubbler (Chemglass # WU-0207-081D) or equivalent
Stainless Ultra-Torr Fitting Union, 1¼ inch OD with Kalrez® o'ring (Swagelok # SS-20-UT-6) or equivalent
Round disc target, 0.75 inch OD×0.062 inch thick, 0.250 inch diameter dimple×0.040 inch deep (ESPI, Electronic Space Products International) or equivalent
Incline target specifications (custom made, Newton Scientific, Cambridge Mass.) or equivalent.
   Addresses
AAPER Alcohol, P.O. Box 339 Shelbyville, KY 40066 USA
Air-Tite Products Co, Inc., 565 Central Drive, Virginia Beach, VA 23454 USA
Alfa Aesar, 30 Bond Street, Ward Hill, MA 01835 USA
Bio-Chem Valve Inc, 85 Fulton Street, Boonton, NJ 07005 USA
CeeKay Supply Inc., 5835 Manchester Avenue, St. Louis, Mo. 63110 USA
Cole-Parmer, 625 East Bunker Court, Vernon Hills, IL 60061 USA
ESPI, Electronic Space Products International, 1050 Benson Way, Ashland, OR 97520 USA
Isoflex USA, PO Box 29475, San Francisco, Calif. 94129 USA
The Mellen Company Inc., 40 Chenell Drive, Concord, NH 03301 USA
Newton Scientific, Inc., 245 Bent Street, Cambridge, Mass. 02141 USA
Parker Hannifin-General Valve Division, 19 Gloria Lane, Fairfield, NJ 07004 USA
Quartz Scientific Inc., 819 East Street, Fairport Harbor, OH 44077 USA
Sigma Aldrich, PO Box 14508, St. Louis, Mo. 63178 USA
Swagelok—Corporate Office, 29500 Solon Road, Solon, OH 44139 USA
Waters Corp, 34 Maple Street, Milford, MA 01757 USA

Advantageously this discovery provides a new way to operate a halogen separation process which will enhance the recovery process, decrease the cost and optimize the efficiency. The purified nuclides are thus recovered in this discovery for further use. This discovery also provides a process with minimal or no human direct exposure to radioactivity and with minimal or not human physical intervention in the process.

While the discovery has been described in terms of various specific embodiments, those skilled in the art will recognize that the discovery can be practiced with modification within the spirit and scope of the claims.

1. An automated method of preparing and recovering each of ⁷⁶Br, ⁷⁷Br and ¹²⁴I from a nuclear bombarded (irradiated) target configured as a round tungsten disk wherein each of ⁷⁶Br, ⁷⁷Br and 124I each are individually respectively recovered.

2. A method in accordance with claim 1 wherein the disk has a configured depression at its center accommodable to receiving and holding material and (b) an inclined or slanted target.

3. A method in accordance with claim 2 wherein the inclined or slanted target has about a 20° inclination with respect to an impinging radiation beam direction comprises placing the irradiated target face up in a quartz tube in the center of a high temperature furnace utilizing a target holder and heating the irradiated target sufficiently to release and recover (isolate) each of ⁷⁶Br, ⁷⁷Br and ¹²⁴I therefrom.

4. A method in accordance with claim 3 wherein 3-way and 4-way solenoid valves are employed in an automated method and the angle of inclination ranges from about 19.2° to about 20.8°.

5. A method in accordance with claim 4 wherein automation of automated process is accomplished by utilizing an electronic control system.

6. A method in accordance with claim 5 wherein the program instructs digital or analog inputs and outputs.

7. A method in accordance with claim 6 wherein PID control instructs the temperature sequence throughout processing.

8. A method in accordance with claim 7 wherein the eluant exiting the cartridge is purified and contains the desired ⁷⁶Br, ⁷⁷Br and ¹²⁴I activity as recovered ⁷⁶Br, ⁷⁷Br and ¹²⁴I.

9. An automated process for preparing and recovering each of ⁷⁶Br, ⁷⁷Br and ¹²⁴I which comprises bombarding ^{76,77}Se and ¹²⁴Te with a beam of protons on a targeted disk with protons to produce ⁷⁶Br, ⁷⁷Br and ¹²⁴I respectively wherein the target is selected from at least one of (a) a round tungsten disk and (b) an inclined target recovering the ⁷⁶Br, ⁷⁷Br and ¹²⁴I by placing the irradiated target face up in a quartz tube in the center of a furnace utilizing a target holder and heating the irradiated target sufficient to release and recover ⁷⁶Br, ⁷⁷Br and ¹²⁴I therefrom using an automated control scheme.

10. A method in accordance with claim 9 wherein the disk has a depression at its center.

11. A method in accordance with claim 9 wherein the target has about a 20° inclination with respect to the beam direction.

12. A method in accordance with claim 9 wherein automation of automated process is accomplished by utilizing an electronic control system.

13. A method in accordance with claim 12 wherein the program provides analog signals and analog outputs.

14. A method in accordance with claim 13 wherein analog signals and analog outputs are used to monitor activity throughout processing.

15. A method in accordance with claim 14 wherein the eluant exiting the cartridge is purified and contains each of desired ⁷⁶Br, ⁷⁷Br and ¹²⁴I activity as recovered individual ⁷⁶Br, ⁷⁷Br and ¹²⁴I.

16. An apparatus for preparing and recovering each of ⁷⁶Br, ⁷⁷Br and ¹²⁴I activity comprises a target suitable for nuclear bombardment, the target selected from (a) a round tungsten disk with a suitably configured depression at its center and (b) an inclined or slanted target having about a 20° inclination with respect to the impinging radiation beam direction wherein is the apparatus includes a 3-way and 4-way solenoid valves, as part of an automated control system wherein each of ⁷⁶Br, ⁷⁷Br and ¹²⁴I are each individually isolated recovered.

17. An automated method of recovering each of ⁷⁶Br, ⁷⁷Br and ¹²⁴I from a nuclear bombarded (irradiated) target selected from a target configured as at least one of (a) a round tungsten disk.

18. A method in accordance with claim 17 wherein the disk has a configured depression at its center accommodable to receiving and holding material and (b) an inclined or slanted target.

19. A method in accordance with claim 18 wherein the target has about a 20° inclination with respect to an impinging radiation beam direction comprises placing the irradiated target face up in a quartz tube in the center of a high temperature furnace utilizing a target holder and heating the irradiated target sufficiently to release ⁷⁶Br, ⁷⁷Br and ¹²⁴I therefrom.

20. A method in accordance with claim 19 wherein 3-way and 4-way solenoid valves are employed in an automated method.

21. An apparatus in accordance with claim 20 wherein the eluant exiting the cartridge is purified and contains desired ⁷⁶Br, ⁷⁷Br and ¹²⁴I activity as recovered ⁷⁶Br, ⁷⁷Br and ¹²⁴I.

22. An apparatus in accordance with claim 21 wherein automation of the operation of the apparatus is accomplished by utilizing an electronic control system.

23. An apparatus in accordance with claim 22 wherein the program provides analog signals and analog outputs.

24. An apparatus in accordance with claim 23 wherein analog signals and analog outputs are used to monitor activity throughout processing.

25. An article of manufacture for preparing each ⁷⁶Br, ⁷⁷Br and ¹²⁴I activity comprising a mechanical target suitable for nuclear bombardment, the target selected from (a) a round tungsten disk with a suitably configured depression at its center and (b) an inclined or slanted target having about a 20° inclination with respect to the impinging radiation beam direction wherein the operation of the article of manufacture is automated and wherein ⁷⁶Br, ⁷⁷Br and ¹²⁴I are independently, separately and respectively recovering each as an independent, separate, respective isotope product.

26. An automated method of recovering ⁷⁶Br, ⁷⁷Br and ¹²⁴I from a nuclear bombarded (irradiated) target selected from a target configured as at least one of (a) a round tungsten disk.

27. A method in accordance with claim 26 wherein the disk has a configured depression at its center accommodable to receiving and holding material and (b) an inclined or slanted target.

28. A method in accordance with claim 27 wherein the target has about a 20° inclination with respect to an impinging radiation beam direction comprises placing the irradiated target face up in a quartz tube in the center of a high temperature furnace utilizing a target holder and heating the irradiated target sufficiently to release ⁷⁶Br, ⁷⁷Br and ¹²⁴I therefrom.

29. A method in accordance with claim 28 wherein 3-way and 4-way solenoid valves are employed in an automated method.

30. An automated method of preparing and recovering ⁷⁶Br, ⁷⁷Br and ¹²⁴I from a nuclear bombarded (irradiated) target selected from a target configured as at least one of (a) a round tungsten disk having at least one of a disk having a configured depression at its center accommodable to receiving and holding material or (b) an inclined or slanted target wherein the target has about a 20° inclination with respect to an impinging radiation beam direction comprises placing the irradiated target face up in a quartz tube in the center of a high temperature furnace utilizing a target holder and heating the irradiated target sufficiently to release ⁷⁶Br, ⁷⁷Br and ¹²⁴I therefrom.

31. A method in accordance with claim 30 wherein 3-way and 4-way solenoid valves are employed in an automated method.

32. An article in accordance with claim 31 wherein the support member for a target to be irradiated comprises a holder for the target having a configuration accommodating a material to be irradiated as a target.

33. An article in accordance with claim 32 wherein the support member is configured as a spoon and has a depression therein to accommodate both target types (a) a round disk and (b) an inclined or slanted target having about a 20° inclination.

34. An article in accordance with claim 33 wherein the support member comprises tantalum.

35. An article in accordance with claim 34 wherein the holder is adapted to releasably hold the target

36. An article in accordance with claim 35 wherein the eluant exiting the cartridge is purified and contains the desired ⁷⁶Br, ⁷⁷Br and ¹²⁴I activity as recovered individually, separately and respectively ⁷⁶Br, ⁷⁷Br and ¹²⁴I.

37. An article in accordance with claim 36 wherein automation of the operation of the apparatus is accomplished by utilizing an electronic control system.

38. An article in accordance with claim 37 wherein the program provides analog signals and analog outputs.

39. An article in accordance with claim 38 wherein analog signals and analog outputs are used to instruct the temperature sequence and to monitor activity throughout processing.

40. A method of controlling an automated operative process for preparing and recovering ⁷⁶Br, ⁷⁷Br and ¹²⁴I comprises bombarding ^{76,77}Se and ¹²⁴Te with a beam of protons on a target to produce ⁷⁶Br, ⁷⁷Br and ¹²⁴I respectively wherein the target is selected from (a) a round tungsten disk with a depression at its center and (b) an inclined target having about a 20° inclination with respect to the beam direction and recovering the ⁷⁶Br, ⁷⁷Br and ¹²⁴I by placing the irradiated target face up in a quartz tube in the center of a furnace utilizing a target holder and heating the irradiated target sufficient to release and recover ⁷⁶Br, ⁷⁷Br and ¹²⁴I therefrom using an automated control scheme which comprises forming a database containing sequence control information and using that database to control the process.

41. A database comprising sequence valve information for controlling an automated operative process for preparing and recovering ⁷⁶Br, ⁷⁷Br and ¹²⁴I comprises bombarding ^{76,77}Se and ¹²⁴Te with a beam of protons on a target to produce ⁷⁶Br, ⁷⁷Br and ¹²⁴I respectively wherein the target is selected from (a) a round tungsten disk with a depression at its center and (b) an inclined target having about a 20° inclination with respect to the beam direction and recovering the ⁷⁶Br, ⁷⁷Br and ¹²⁴I by placing the irradiated target face up in a quartz tube in the center of a furnace utilizing a target holder and heating the irradiated target sufficient to release and recover ⁷⁶Br, ⁷⁷Br and ¹²⁴I therefrom using an automated control scheme wherein the database comprises a sequence of valve openings and valve closings.

42. A database for controlling an automated operative process in accordance with claim 41 wherein the disk has a depression at its center.

43. A database for controlling an automatic operative process in accordance with claim 42 wherein the target has about a 20° inclination with respect to the beam direction.

44. A database for controlling an automatic operative process in accordance with claim 43 recovering the ⁷⁶Br, ⁷⁷Br and ¹²⁴I by placing the irradiated target face up in a quartz tube in the center of a furnace utilizing a target holder and heating the irradiated target sufficient to release and recover ⁷⁶B, ⁷⁷Br and ¹²⁴I therefrom.

45. A database for controlling an automatic operative process in accordance with claim 44 using an automated control scheme which comprises forming a database containing sequence control information and using that database to control the process.
